(19) United States
(12) Patent Application Publication
(10) Pub. No.: US 2005/0115635 A1
(43) Pub. Date: Jun. 2, 2005

(54) Steam expander for loose fill material

(76) Inventors: Harry Bussey JR., Marco Island, FL (US); Buddy Harry Bussey III, Atlantic Highlands, NJ (US)

Correspondence Address: Francis C. Hand, Esq.;c/o Carella, Byrne, Bain, Gilfillan, Cecchi,, Stewart & Olstein, 6 Becker Farm Road, Roseland, NJ, 07068, US

(21) Appl. No.: 10/725,127

(22) Filed: Dec. 1, 2003

(51) Int. Cl. B67C 3/26

(52) U.S. Cl. 141/255

(57) ABSTRACT

The steam expander a pair of hoppers for supplying expandable loose fill material via a pair of housings into a steam chamber. A paddle is mounted in the chamber to rotate about a central axis and carries a pair of scoops. Each scoop is disposed in spaced relation to the outlets of the housings for scooping loose fill material delivered into the steam chamber peripherally of the steam chamber without creating dust and while creating a space behind the scoop for freshly supplied material. Each housing has a screw with flights of reduced diameter at the inlet from a hopper to create an annular space to receive the loose fill material and avoid the creation of dust.

This invention relates to a steam expander for a loose fill material.

As is known, various types of expanders have been employed for expanding latent foaming loose fill material. Typically, a charge of loose fill material in a latent foaming state is deposited into a chamber which is heated so that the individual elements of the charge are expanded under the heat generated in the chamber. In some cases, it has been known to move a charge of loose fill material by means of a conveyor screw into a heated steam chamber so that the loose fill material can be expanded on a continuous basis. However, use of a conveyor screw to move the elements of the loose fill material causes flaking and cracking of the elements. As a result, dust is created within the moving mass of material. Further, in some cases, the steam chamber has been provided with rotating paddles in order to break up any clumping of the material at the entrance to the steam chamber as well as to convey the material to an outlet of the steam chamber. These paddles, in turn, cause further flaking and cracking of the elements and an accumulation of more dust in the mass of material. Consequently, when the expanded loose fill material is packaged and subsequently placed into use, the accumulated dust creates problems for the user and the environment to which the loose fill material is exposed.

Accordingly, it is an object of the invention to reduce the amount of dust created during the expansion of latent foaming loose fill material.

It is another object of the invention to avoid cracking or splitting of the elements of a charge of latent foaming loose fill material during expansion thereof.

Briefly, the invention provides a steam expander with at least one housing that receives a flow of loose fill material, a steam chamber in communication with an outlet of the housing to receive the loose fill material and a paddle frame rotatably mounted in the steam chamber to rotate about a central axis. In accordance with the invention, the paddle frame has at least one scoop mounted on a periphery thereof that extends longitudinally in spaced parallel relation to the central axis and that is disposed in spaced relation to the outlet of the housing for scooping loose fill material delivered into the steam chamber peripherally of the steam chamber.

Preferably, the paddle frame is provided with a pair of scoops disposed in diametrically spaced apart relation. Each scoop is positioned to pass a short distance, for example, approximately 3 to 4 inches, from the outlet from the housing so that they elements of the loose fill material are gently moved away from the entrance to the steam chamber to avoid clumping thereat and without chipping or flaking of the surfaces of the elements.

In addition, the housing has an inlet to receive a flow of loose fill material and a screw that is rotatably mounted in the housing with a plurality of flights for conveying the loose fill material received towards the outlet of the housing. In accordance with the invention, at least some of the screw flights that are disposed in alignment with the inlet are of a smaller radius than the remainder of the flights. In this way, an annular space is provided about the flights of reduced diameter to allow the elements of the loose fill material to the gently received and conveyed along the remainder of the screw without being unduly compressed. As a result, chipping, cracking and flaking of the elements is avoided.

In order to provide for multiple passes of a latent foaming loose fill material through the steam chamber, the steam expander is provided with a second hopper and a second housing similar to the first housing. In this embodiment, one hopper is used to feed a latent foaming loose fill material into the steam expander for expansion to a first state of expansion. After the expanded material has been cured, the material is passed through the second hopper into the second housing and conveyed in a similar fashion into the steam expander for further expansion. In this regard, the second housing is larger diameter than the first housing in order to accommodate the expanded state of the elements of the loose fill material. After the loose fill material has been expanded and cured in the second stage, the loose fill material may be recycled through the second hopper and second housing into the steam expander for a third and final stage of expansion and curing.

These and other objects and advantages of the invention will be, more apparent from the following detailed description taken in conjunction with the accompanying drawings wherein:

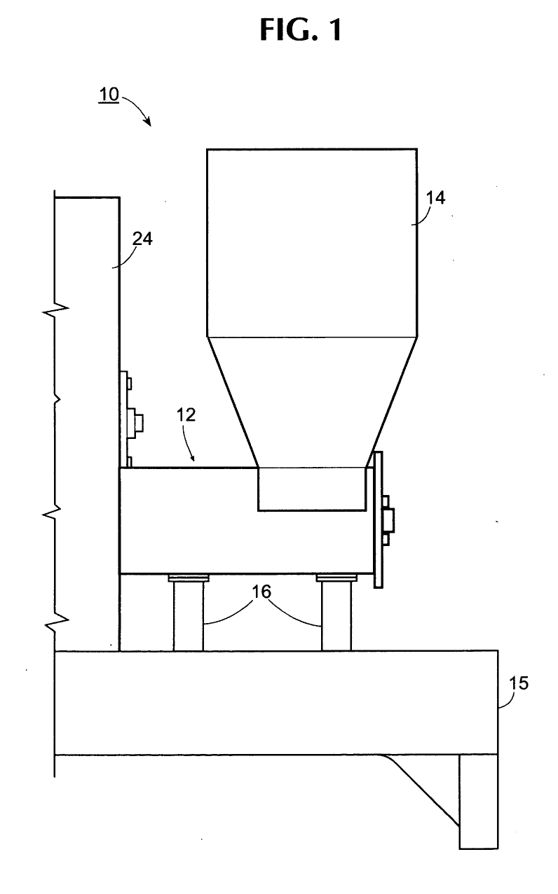

FIG. 1 illustrates a left side view on a steam expander constructed in accordance with the invention;

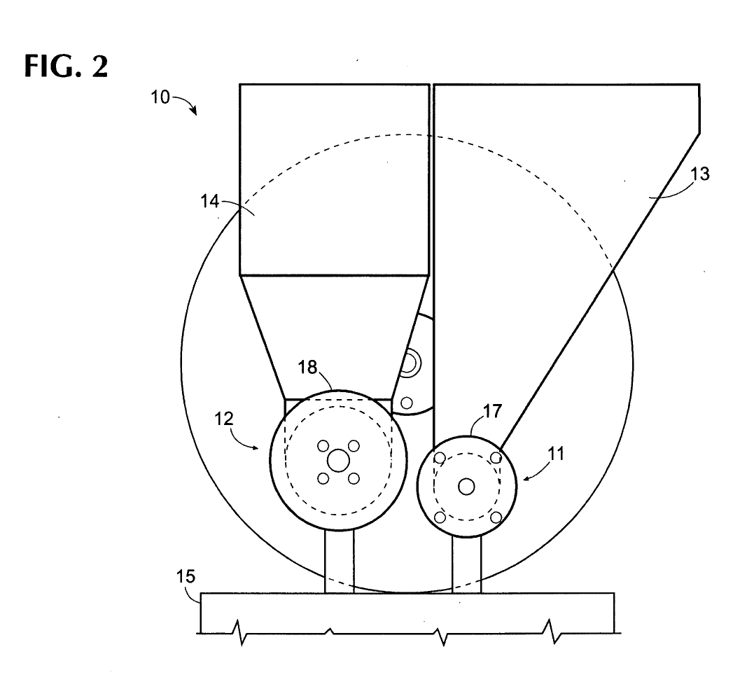

FIG. 2 illustrates a front view of the steam expander of FIG. 1;

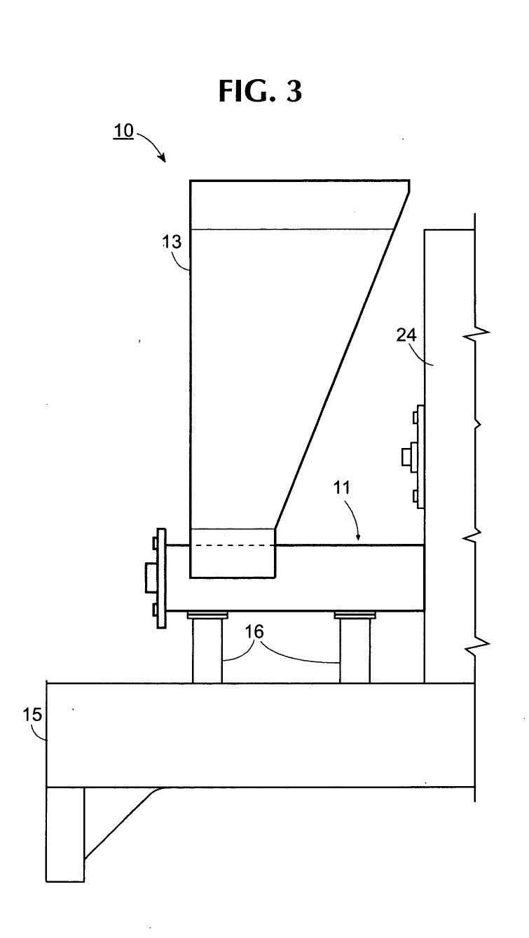

FIG. 3 illustrates a right side view of the steam expander of FIGS. 1 and 2;

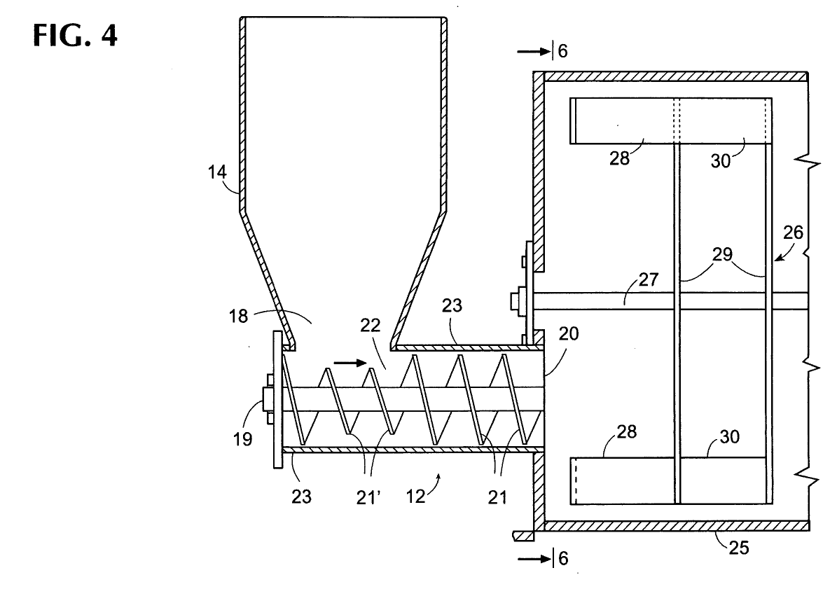

FIG. 4 illustrates a part cross-sectional side view of the steam expander of FIG. 3;

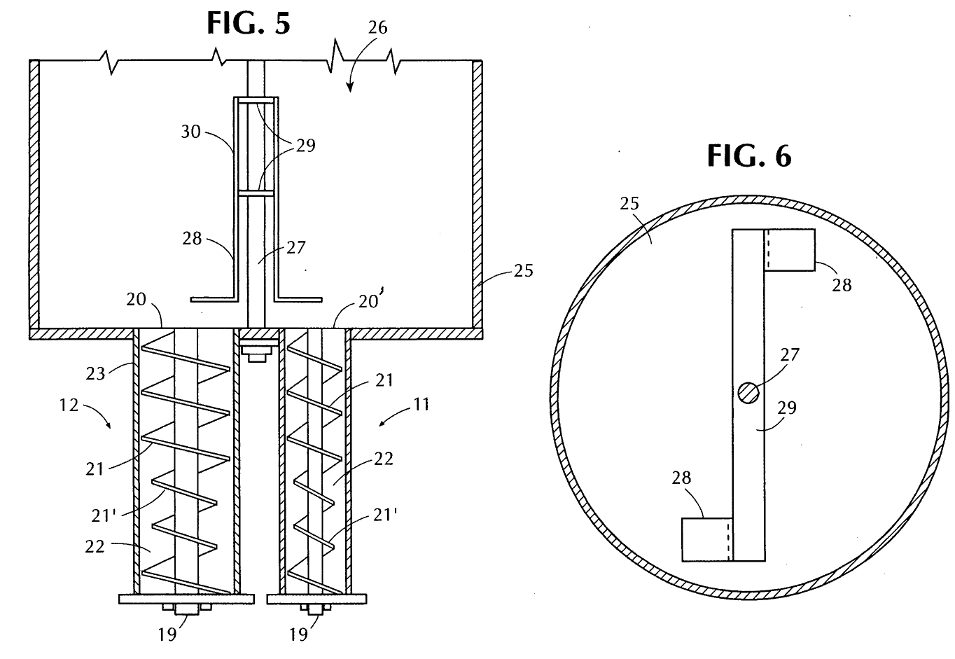

FIG. 5 illustrates a part cross-sectional top view of the steam expander of FIG. 3; and

FIG. 6 illustrates an axial view of a paddle frame constructed in accordance with the invention.

Referring to FIGS. 1, 2 and 3, the steam expander 10 is provided with a pair of housings 11,12, for example of cylindrical shape, each of which is connected with a hopper 13,14. As indicated the two housings 11,12 are mounted on a common frame 15 via separate vertical supports 16.

As shown in FIG. 2, one hopper 13 is of tapered shape and communicates through an opening in the bottom with an inlet 17 of one housing 11 in order to deliver a flow of latent foaming loose fill thermoplastic material into the housing 11. The other hopper 14 is of larger capacity and has an opening in the bottom that is of greater width than that of the first hopper 13 in order to deliver loose fill material that has been at least partially expanded through an inlet 18 of the housing 12. As indicated, the inlet 18 of the housing 12 is larger than the inlet 17 of the housing 11 to accommodate the at least partially expanded loose fill material.

The manner in which the hoppers 13,14 operate to feed material to the housings 11,12 is well known and need not be further described.

Referring to FIG. 4, the housing 12 is provided with a screw 19 that is rotatably mounted therein in order to convey loose fill material received through the inlet 18 towards an outlet 20 of the housing 12 in a conventional manner. In this respect, the screw 19 has a plurality of flights 21 for conveying the loose fill material towards the outlet 20 during rotation of the screw 19. As illustrated, the flights 21′ disposed in alignment with the inlet 18 are of a smaller radius than the remainder of the flights 21. In this way, an annular space 22 is provided between the flights 21′ of reduced diameter and the surrounding wall 23 of the housing 12, for example, as described in U.S. Pat. No. 4,379,106 to prevent breaking of the elements during travel along the screw 19. This annular space 22 allows the received loose fill material to be circumferentially disposed about the screw 19 and conveyed in a gentle manner without compression of the individual elements of the material. In this way, fracturing, splitting and flaking of the elements is avoided.

The other housing 11 is of smaller diameter than the housing 12 and is provided with a screw (not shown) of similar construction to the screw 19 but of smaller diameter to fit into the housing 11 and need not be further described. Each screw is driven from a separate drive (not shown) from the other located within a motor housing 24 (see FIG. 1) mounted on the frame 15.

Referring to FIGS. 4 and 5, a steam chamber 25 is disposed in direct communication with the outlet 20 of the housing 12 to receive loose fill material therefrom. In addition, the steam chamber 25 is in direct communication with the outlet (not shown) of the second housing 11 to receive loose fill material therefrom. The steam chamber 25 is otherwise of conventional construction such as described in U.S. Pat. No. 4,379,106 and need not be further described.

Referring to FIGS. 4 and 5, a paddle frame 26 is rotatably mounted in the foremost end of the steam chamber 25 to rotate with a central shaft 27 located on a central axis of the steam chamber 25. This paddle frame 26 carries a pair of scoops 28 that are mounted on the periphery of the paddle frame 26 at diametrically spaced apart points. Each scoop 28 extends longitudinally of the chamber 25 in spaced parallel relation to the central axis of the chamber 25. Each scoop 28 is also disposed in spaced relation to the outlet 20 of the housing 12 for scooping loose fill material delivered into the steam chamber 25 peripherally of the steam chamber 25 and away from the outlet 20.

Additional paddle frames (not shown) may also be provided in the steam chamber 25 for purposes such as described in U.S. Pat. No. 4,379,106.

The spacing of each scoop 28 from the outlet 20 of the housing 12 and the not shown outlet of the housing 11 is sufficient to allow the scoop 28 to gently move the delivered loose fill material away from the inlet end of the steam chamber 25 to avoid accumulation thereat without fracturing, splitting or flaking of the individual elements of the material. In this respect, each scoop 28 has an L shape but made also be made of other suitable shapes, such as a curved or concave shape. Each scoop 24 not only extends longitudinally of the chamber 25 as shown in FIG. 5 but also extends peripherally of the chamber 25 as indicated in FIG. 6. This shape allows the scoop 28 to move a mass of elements away from the outlet while at the same time creating an empty space behind the scoop 28 into which freshly delivered material can enter.

As illustrated in FIG. 5, the scoops 28 are radially spaced from the wall of the chamber 25 in order to avoid jamming of the elements of the loose fill material therebetween.

The paddle frame 26 is of skeletal construction being formed of a pair of plates 29 that are secured coaxially to and along the central rotatable shaft 27. These plates 29 support a pair of paddles 30 therebetween which serve to agitate and move the loose fill material delivered into chamber 25. The L-shaped scoops 28 are connected as by welding to the forward plate 29 in line with the paddles 30.

By way of example, the plates 29 have a length of 31 ¼ inches and a width of 3 inches. Each scoop 28 has a height of 4 inches and projects peripherally (i.e. perpendicularly) from the plane of the plates 25 a distance of 4 inches and projects longitudinally forward a distance of 4 inches.

In operation, a mass of latent foaming loose fill thermoplastic material is delivered into the first hopper 11 and passed through the housing 13 into the steam chamber 21. During this time, the elements of loose fill material are heated and expanded. For example, the loose fill elements may be expanded from a bulk density of 30 pounds per cubic foot to achieve an expanded bulk density of 0.6 pounds per cubic foot.

Since the latent foaming loose fill elements are hard, any harsh mechanical working of the elements may cause flaking or cracking of the elements which, in turn, may lead to the formation of dust. Consequently, the working parameters of the housing 11 and paddle frame 26 are such as to minimize the risk of dust formation.

During operation of the screw in the housing 11, the screw 19 in the other housing 12 is also rotating and vice versa to prevent back feed of the loose fill material. In this respect, the speed of the screw in the housing that is not delivering material to the steam chamber 21 is operated at a slow speed, that is at a speed less than the normal operating speed.

After a suitable curing time has passed, the expanded material is delivered into the second hopper 12 via suitable means such as described in U.S. Pat. No. 4,379,106 and passed through the second housing 14 into the steam chamber 25 for a second stage of heat expansion. For example, during this time, the loose fill material is expanded to achieve a bulk density of 0.3 pounds per cubic foot. Again, after a suitable curing time has passed, the loose fill material is re-cycled through the hopper 12 and housing 14 into the steam chamber 25 for a third pass. During this time, the loose fill material is expanded to achieve a bulk density of 0.18 to 0.2 pounds per cubic foot.

Any number of passes may be used to expand the original mass of latent foaming loose fill material. However, three passes should be sufficient to reduce the overall weight per cubic foot of the material to a suitable range for packaging purposes.

During passage through the respective housings 13,14 and steam chamber 25, the loose fill material is gently moved without fracturing, splitting or flaking of the individual elements. In this way, little or no dust is created in the final product. Hence, when the expanded loose fill material is used by the ultimate consumer, there is little or no dust to contend with by the consumer and the surrounding environment.

The invention thus provides a clean and economical apparatus for expanding latent foaming loose fill material without creating dust.

1. A steam expander comprising
at least one hopper for supplying expandable loose fill material;
at least one housing having an inlet in communication with said hopper to receive a flow of loose fill material therefrom and an outlet for discharging the received loose fill material therefrom;
a screw rotatably mounted in said housing for conveying loose fill material received through said inlet towards said outlet;
a steam chamber in communication with said outlet of said housing to receive loose fill material therefrom; and
a paddle frame rotatably mounted in said chamber to rotate about a central axis, said paddle frame having at least one scoop mounted on a periphery thereof and extending longitudinally thereof in spaced parallel relation to said central axis, said scoop being disposed in spaced relation to said outlet of said housing for scooping loose fill material delivered into said steam chamber peripherally of said steam chamber.

2. A steam expander as set forth in claim 1 wherein said paddle frame has a pair of said scoops disposed on diametrically opposite sides thereof.

3. A steam expander as set forth in claim 2 wherein each said scoop is of L shape.

4. A steam expander as set forth in claim 1 wherein said screw has a plurality of flights for conveying received loose fill material towards said outlet during rotation of said screw, at least some of said flights being disposed in alignment with said inlet and being of a smaller radius than the remainder of said flights.

5. A steam expander comprising
a pair of hoppers for supplying expandable loose fill material;
a pair of housings, one of said housings having an inlet in communication with one of said hoppers to receive a flow of loose fill material therefrom and a second of said housings having an inlet in communication with the other of said hoppers to receive a flow of loose fill material therefrom, each said housing having a respective outlet for discharging the received loose fill material therefrom;
a pair of screws, one of said screws being rotatably mounted in one of said housings and disposed for conveying loose fill material received through said inlet of said one housing towards said outlet thereof and the other of said screws being rotatably mounted in the other of said housings and disposed for conveying loose fill material received through said inlet thereof towards the said outlet thereof;
a steam chamber in communication with said outlets of said housings to receive loose fill material therefrom; and
a paddle frame rotatably mounted in said chamber to rotate about a central axis, said paddle frame having at least one scoop mounted on a periphery thereof and extending longitudinally thereof in spaced parallel relation to said central axis, said scoop being disposed in spaced relation to said outlets of said housing for scooping loose fill material delivered into said steam chamber peripherally of said steam chamber.

6. A steam expander as set forth in claim 5 wherein said paddle frame has a pair of said scoops disposed on diametrically opposite sides thereof.

7. A steam expander as set forth in claim 6 wherein each said scoop is of L shape.

8. A steam expander as set forth in claim 5 wherein said screw has a plurality of flights for conveying received loose fill material towards said outlet during rotation of said screw, at least some of said flights being disposed in alignment with said inlet and being of a smaller radius than the remainder of said flights.
